(19) United States
(12) Patent Application Publication
(10) Pub. No.: US 2019/0214690 A1
(43) Pub. Date: Jul. 11, 2019

(54) COOLING MODULE FOR A BATTERY, BATTERY FOR A VEHICLE AND METHOD FOR PRODUCING A COOLING MODULE

(71) Applicant: VALEO KLIMASYSTEME GMBH, Bad Rodach (DE)

(72) Inventor: Roland Haussmann, Bad Rodach (DE)

(73) Assignee: VALEO KLIMASYSTEME GMBH, Bad Rodach (DE)

(21) Appl. No.: 15/772,736

(22) PCT Filed: Nov. 2, 2016
(86) PCT No.: PCT/EP2016/076355

§ 371 Date: May 1, 2018

(30) Foreign Application Priority Data
Nov. 2, 2015 (DE) 10 2015 118 747.7

(51) Int. Cl. H01M 10/613; H01M 10/625; H01M 10/6568

(52) U.S. Cl. CPC H01M 10/613; H01M 2220/20; H01M 10/6568; H01M 10/625

(57) ABSTRACT

The invention relates to a cooling module for the active cooling of a battery (10) which has at least two battery modules (12), with a profile element (20) which has at least one interior space (22) for the passage of a cooling medium and at least two side surfaces (24) which face away from one another and are designed to be assigned in each case to one of the battery modules (12), wherein filling material (26) for producing a heat-conducting connection between the profile element (20) and the battery modules (12) is arranged on the side surfaces (24). With the cooling module, cost-effective and reliable cooling of a battery is achieved by the fact that a contact surface (25) which is formed between the respective side surface (24) and the filling material (26) arranged on said side surface (24) is smaller than the respective side surface (24).

The invention relates to a cooling module for the active cooling of a battery which has at least two battery modules, with a profile element which has at least one interior space for the passage of a cooling medium and at least two side surfaces which face away from one another and are designed to be assigned in each case to one of the battery modules, wherein filling material for producing a heat-conducting connection between the profile element and the battery modules is arranged on the side surfaces. In addition, the invention relates to a battery for a vehicle with such a cooling module. Finally, the invention relates to a method for producing a cooling module.

Cooling modules of the type mentioned at the beginning are used, for example, for cooling high-voltage batteries in electric and hybrid vehicles, in particular with an internal combustion engine or a fuel cell. The cooling modules serve to keep the temperature of individual battery cells, which are combined to form battery modules, in or below a predetermined temperature range during operation. A lithium-ion accumulator should be operated, depending on the chemical composition, below a temperature range of 40° C. to 50° C. in order to achieve optimum power during the charging and discharging process, and also a large number of possible charging cycles and therefore a long service life. These stipulations are realized with the aid of active cooling of batteries of this type.

For the cooling, the battery modules or battery cells of a battery can be arranged directly in a cooled immersion bath or can be air-cooled. Furthermore, contact coolers are known which lie against a battery surface to be cooled and through which a cooling medium flows.

WO 2012/013315 A1 describes a cooling arrangement with such a contact cooler for a battery, wherein flat tubes through which a coolant flows lie against the bottom of the battery to be cooled. A direct metallic contact is formed here between the metallic flat tubes and the metallic underbody of the battery. The flat tubes are braced against the underbody of the battery with the aid of springs in order to achieve as flat a contact as possible between the underbody and the flat tubes and to compensate for possible manufacturing tolerances of the flat surfaces.

However, the arrangement described in WO 2012/013315 A1 has the disadvantage that a reliable, flat contact of the contact surfaces cannot be ensured because of the limited mechanical load-bearing capacity of the battery and the manufacturing tolerances of the flat surfaces lying against one another. The bracing forces customarily tolerable by a battery module with a contact surface of, for example, approx. 6 dm² lie within the range of approx. 2000 N. Depending on the manufacturing—and/or temperature-induced deviations in shape and position of the contact surfaces and springs, the effectively acting bracing forces in such an arrangement may be less than 1000 N because of tolerances, if the maximum value of 2000 N may not be exceeded. In this case, sufficient contact of the mutually assigned metallic contact surfaces of battery and flat tubes is no longer ensured and the battery is insufficiently cooled. Losses in terms of power and service life of the battery result therefrom. In addition, in the described arrangement, each module of the battery is cooled individually, wherein the large number of required cooling units and the associated spring elements lead overall to a high weight of the arrangement.

WO 2009/146876 A1 describes a device for cooling a battery, wherein the individual cells of the battery are arranged on a cooled baseplate. In this design, narrow, vertically arranged cells of a battery are braced between two likewise vertically extending cooling fins by means of a central spring element which is enclosed by two metal plates. It is disadvantageous here that a defined, homogeneous contact of the cells, which are to be cooled, with the vertically extending cooling fins is not achieved. In addition, the spring elements which are required for the vertical arrangement and are enclosed by metal plates increase the weight of the arrangement.

JP 2008181733 A discloses a cooling system for vehicle batteries. A plate-like cooling element is braced here between two battery modules, which are arranged adjacent to each other, with the aid of a clip mechanism. The cooling element completely covers those surfaces of the battery modules which are assigned to the cooling element. As already described above with reference to WO 2012/013315 A1, there is also the problem, in the case of the arrangement known from JP 2008-181733 A, of achieving a homogeneous, flat contact between the cooling element and the battery modules to be cooled, despite the limited tolerable bracing forces of the battery module.

Cooling systems, as described, for example, in JP 2008181733 A or in WO 2012/013315 A1, which provide resiliently elastic bracing of cooling elements and battery modules, are susceptible in respect of dynamic loadings in the ready fitted state. For example, vibration occurring in the driving mode of a vehicle may lead to the flat contact between cooling element and battery module within the range of the resiliently elastic bracing of the contact surfaces being at least temporarily removed. In this case, reliable cooling of the battery is not ensured, which can lead to the losses already previously discussed in respect of the power and the service life of the battery.

Furthermore, it is known to arrange a cooling element between two adjacent battery modules, wherein the cooling element is provided for cooling the two modules, and the heat-conducting contact between the cooling element and the battery module to be cooled in each case is realized via a silicone pad provided between the cooling element and the battery module. The silicone pad covers the entire surface of the cooling element facing the battery module and serves to compensate for manufacturing tolerances. The width of the intermediate space in which the cooling element is arranged can thus fluctuate by a tolerance range of +/−0.3 mm. The silicone pad serves to compensate for said manufacturing tolerances and is deformed to a greater or lesser extent, depending on the width of the intermediate space, during the installation of the cooling element. In this manner, flat contact with the battery modules is produced, and therefore a homogeneous transfer of heat between the cooling element and the battery module to be cooled in each case is achieved.

The thickness of the silicone pads has to be dimensioned in such a manner that, in the region of the maximum width of the intermediate space, reliable contact of the respective pad with the battery module and the cooling element is ensured. There is the problem here that said silicone pads correspondingly greatly deform in the region of a minimum width of the intermediate space, that is to say have to be pressed out of the intermediate space between battery and cooling element. Even when very soft materials are used for the pad (Shore hardness (00) of between 20 and 40), the battery modules may be damaged, in particular distorted, by the bracing forces which are required. If the installation or bracing force between the components which are to be braced is limited, there is the problem that the silicone pads are not sufficiently compressed in regions of minimal width of the intermediate space, and therefore an air gap remains between the cooling element and the assigned battery module in regions of maximum width of the intermediate space. Due to the poor heat conduction in the region of the air gap (approx. 0.02 W/(m²K)), the battery module is insufficiently cooled, and therefore the battery may overheat.

Finally, it is known to apply pasty filling materials between two adjacent battery modules, which filling materials because of their low viscosity require only small compression or bracing forces during the installation. However, pasty filling materials have the disadvantage that the application thereof is complicated and the pastes when stressed for a prolonged period under high operating temperatures have a tendency to flow out of the intermediate space to be filled, in particular when the intermediate space extends vertically in the ready mounted state.

Proceeding from the above-described prior art, the invention is based on the technical problem of specifying a cooling module for the active cooling of a battery, which cooling module does not have the above-described disadvantages or at least has them to a lesser extent, and reliable cooling of a battery is ensured in particular in a cost-effective manner. Furthermore, the intention is to specify a battery for a vehicle and a method for producing a cooling module.

The above-described technical problem is solved by a cooling module for the active cooling of a battery which has at least two battery modules, with a profile element which has at least one interior space for the passage of a cooling medium and at least two side surfaces which face away from one another and are designed to be assigned in each case to one of the battery modules, wherein filling material for producing a heat-conducting connection between the profile element and the battery modules is arranged on the side surfaces of the profile element. The filling material here in each case covers only a part of the side surface of the profile element.

“Cover only a part of the side surface” is intended to be understood according to the invention as meaning that the filling material leaves free a significant percentage portion of the respective side surface, which is assigned to a battery module, of the profile element. In other words, the area of the contact surface between the respective side surface and the filling material arranged on said side surface is smaller than the area of the respective side surface of the profile element. In the ready mounted state, one or more regions, in particular air gaps, which are not filled or covered by the filling material, are therefore formed between a battery module to be cooled and a respective side surface, which is assigned to the battery module, of the profile element.

In comparison to previously known solutions which provide side surfaces completely covered with filling material, the bracing or compression forces can be reduced. This is because, during the installation, overall less filling material has to be compressed between the battery modules and the profile element, or the bracing forces act on a smaller contact surface. The effect can thus already be achieved with a smaller bracing force that the filling material lies substantially completely against the battery module and the profile element. The reliable contact with the filling material used ensures homogeneous cooling of the battery modules. The compression forces can be reduced by up to a tenth in comparison to previously known solutions.

The reduction in the required compression forces enables the mechanical loading of the battery modules to be reduced. In particular, the compression forces acting on the battery module in the ready mounted state can be smaller than 2000 N.

When cooling module and battery modules are installed with a predefined compression force—in comparison to an arrangement with a side surface which is completely covered with filling material—the compression force is distributed according to the invention over a smaller contact surface. Consequently, given the same compression force or bracing force, the filling material is more greatly compressed, and therefore a distance formed between the profile element and the respective battery module can be reduced with the same compression force. The predetermined compression force can be in particular a compression force which is maximally tolerable by the respective battery module and can be, for example, smaller than or equal to 2000 N.

In previously known solutions according to the prior art, as large a contact surface as possible between the profile element and the battery module to be cooled is sought in order to avoid air gaps. It has surprisingly been shown that the cooling power required for cooling a respective battery module can be achieved with the cooling module according to the invention despite the reduced contact surface. According to the invention, the contact surface is reduced in favour of a defined contact and greater compression of the filling material. According to the invention, the contact surface formed between the profile element and filling material in the ready mounted state can be reduced, for example, to up to a third of the area of the side surface. Overall, the costs and the weight of the cooling module can be reduced by the reduced quantity of filling material.

The profile element of the cooling module according to the invention can be, for example, an extrusion profile. The profile element can have a plurality of internal channels which are suitable for the passage of a cooling medium. The channels can have a substantially circular or rectangular cross section and/or can be arranged substantially parallel to one another. The channels can preferably be extended along a longitudinal direction of the profile element. The side surfaces of the profile element can be of substantially flat and/or rectangular design and/or can be oriented parallel to one another. The profile can be a flat profile, wherein the thickness of the profile that is bounded by the side surfaces corresponds to less than a quarter, preferably to less than 15%, furthermore preferably to less than 10%, of the width of the profile, wherein the width of the profile is measured transversely with respect to a longitudinal direction of the profile. The profile element can therefore be a flat tube which in particular can have a substantially rectangular cross section. The thickness of the profile element can be, for example, 2.5 mm.

According to a development of the cooling module, the filling material is arranged in strips on the side surfaces, wherein the strips assigned to a side surface are at a distance from one another, and wherein the strips are in particular arranged substantially parallel to one another. At least two, preferably a plurality of, separate filling material strips can thus be arranged on a side surface. By means of the clearance formed between the strips, the filling material, in the event of a compression, can expand better in a direction oriented transversely with respect to the compression force. The filling material arranged in strips can therefore be more easily deformed in comparison to an associated pad with the same contact surface and thickness, as a result of which tolerances can be better compensated for.

A further refinement of the cooling module according to the invention provides that the profile element has narrow sides which are adjacent to the side surfaces of the profile element, and in that at least a part of the filling material is arranged in an edge region of a side surface, which edge region is assigned to the narrow sides. In the event of a compression, the filling material provided in the edge region can be pushed in a particularly simple manner into a clearance assigned to the narrow sides, and therefore only small compression forces are required for deforming the filling material in the edge region.

According to a development of the invention, an arrangement which is advantageous with regard to the required compression forces can be achieved in that at least one strip which is composed of filling material and is arranged in the edge region of the side surface is adjacent to the narrow side assigned to the edge region, and/or in that at least one outer strip assigned to the edge region is wider than an inner strip arranged at a distance from the edge region. The width of the filling material that is increased in the edge regions takes account of the fact that, in the event of a compression, the outer strips may be pushed to a greater extent, in particular whenever a clearance between battery module and side surface, which clearance is arranged in the edge region of the narrow sides, is widened outwards in the direction of the narrow sides. This is the case, for example, if a radius or a chamfer is formed between the side surface and an adjacent narrow side. Therefore, the compression forces required for compressing the outer strips to a certain size, for example a predetermined thickness, lie significantly below the values which are necessary in order to deform an internal strip and may be, for example, merely 50% of the forces which are necessary for deforming an internal strip.

In order, in the event of a compression, to assist the flow of the filling material arranged in the edge region, the side surfaces and the narrow sides, according to an advantageous development of the cooling module according to the invention, can merge smoothly into one another, wherein in particular a radius is formed between the side surfaces and the narrow sides. Smoothly means here that an edge is not formed between the side surfaces and the narrow sides. A transition region formed between the side surfaces and the narrow sides can thus be, for example, curved in a cross section oriented perpendicularly to the side surfaces. In particular, a transition region formed between the side surfaces and the narrow sides can be a continuous tangent or curvature in a cross section oriented perpendicularly to the side surfaces.

The condition 2 mm≤a≤10 mm can apply to a distance a formed between adjacent filling material strips. The greater the number of filling material strips in an overall identical contact surface, the more easily can the filling material be deformed, and the required installation forces are reduced.

According to a further refinement of the cooling module, the area of the contact surface is 5% to 80% of the area of the respectively assigned side surface, wherein the filling material is in a preassembled, uncompressed state. Consequently, only 5% to 80% of the respective side surfaces of the profile element are covered with filling material. The smaller the contact surface is configured to be in comparison to the side surface, the smaller is that part of the side surface which is covered by filling material.

The area of the contact surface can be at least 30% and at most 90% of the area of the side surface in a ready mounted, in particular compressed state. In particular, the cross section of the filling material strip in the undeformed state and with predetermined tolerances for an intermediate space to be filled between side surfaces and battery module can be selected in such a manner that this condition is met. Despite the reduced contact surface, the required cooling power can be delivered.

The filling material can be an elastomer, in particular a soft silicone, wherein the filling material can contain additives for increasing the heat conductivity. The filling material can preferably already be deformed with low forces at room temperature, and therefore, in the ready mounted state, the respectively assigned battery module is subjected to little mechanical loading.

In order to compensate for manufacturing tolerances formed between a side surface and a respective battery module, the condition 0.3 mm T 0.8 mm can apply to the thickness T of the filling material. For more exacting tolerances between the cooling module and the battery modules to be cooled, a small thickness T of the filling material can be selected, whereas, in order to compensate for greater tolerance ranges, a higher filling material thickness T can be selected. In a non-compressed state, the thickness T of the filling material is determined here in a direction perpendicular to the respective side surface. The filling material can preferably be arranged with a thickness of T=0.5 mm on a side surface in order to compensate, for example, for flatness and/or evenness tolerances of +/−0.3 mm.

According to a development of the cooling module, the condition 1≤H≤10 Shore (A) or the condition 20≤H≤70 Shore (00) applies to the hardness H of the filling material. The respective Shore hardness is determined in accordance with the respectively relevant DIN, in particular DIN 53505 or DIN 7868. Filling material of the above-described hardness ranges can be particularly easily deformed.

In order to achieve the cooling power required during the operation of the cooling module, according to a refinement of the cooling module the condition 0.7 W/(m*K)≤λ≤8 W/(m*K) applies to the heat conductivity λ of the filling material. The indicated values of the heat conductivity of the filling material apply in particular at room temperature in an uncompressed state.

The filling material can preferably be a material which forms an adhesive connection with the profile element and/or with the battery module, wherein those surfaces of profile element and battery element which are assigned to the filling material can be in particular metallic or can preferably be composed of aluminium or an aluminium alloy.

The filling material can be covered on the cooling module by a protective film. This protective film serves for protecting the filling material during the storage and the transport of the cooling modules and can be removed before the final installation of the cooling module. The protective film can be a backing film on which the filling material is first of all provided separately from the profile element. The filling material can be arranged on the backing film at predetermined distances in strips. In this manner, the arrangement of the filling material strips can already be predetermined on the backing film, and therefore, by simple alignment and application of the backing film on the side surface, the required arrangement of the filling material strips on the profile element can be achieved.

The technical problem on which the invention is based is furthermore solved by a battery for a vehicle, with at least two battery modules and a cooling module for the active cooling of the battery modules, wherein the cooling module is arranged between the battery modules and is designed in a manner according to the invention.

The battery modules can each be composed of a plurality of battery cells which are tightly packed or lined up in a row next to one another. The battery cells can be prismatic cells with a substantially rectangular basic shape. Such a battery cell can have a heat-conducting bottom surface which is substantially flat. The adjacent bottom surfaces of tightly packed battery cells can form a bottom surface of the battery module. The bottom surface of the battery module can have a tolerance range of +/−0.3 mm which arises from deviations in dimensions and flatness. The bottom surfaces of two adjacent battery modules can be assigned to the side surfaces of the cooling module.

In a battery according to the invention, the temperature differences between a battery module to be cooled and the profile element can be kept within an appropriate range even at a maximum temperature of the battery module to be cooled in each case. The temperature difference between a cooling medium arranged within the profile element and a side surface of the profile element can be 1.5 K, the temperature difference between said side surface and a surface facing the side surface, in particular bottom surface, of the battery can be 6.5 K, and the temperature difference due to the drop in pressure when the cooling medium expands can be 2 K. The temperature difference between the bottom surface of the battery and the side surface of the profile element is preferably smaller than 7 K. For reliable cooling, overall a temperature difference of 10 K is required here between the cooling medium and the battery module. In the event of an evaporation temperature of the cooling medium of 5° C., a temperature of 15° C. therefore arises in the region of that surface of the battery which faces the side surface.

The side surfaces of the profile element can each be assigned bottom surfaces of the battery module to be cooled, wherein the side surfaces and the bottom surfaces can be arranged substantially parallel to one another. An intermediate space which, in the ready mounted state of the battery, can have a clear width of 0.05 to 0.5 mm can be formed between the side surfaces and the bottom surfaces, wherein the intermediate space is only partially filled with filling material. In the ready mounted state, the cooling module can be braced or compressed between the battery modules with the aid of threaded rods and nuts.

The battery can have a plurality of cooling modules. The cooling modules can be arranged along a longitudinal direction of the battery and at a distance from one another, wherein the cooling modules can be extended in particular parallel to one another. The cooling modules can each lead on opposite end sides into a pipe, wherein the pipes are joined to a cooling circuit.

According to a development of the battery, the condition 0.8*(G/λ)\hat{ }0.3<(B/A)<1.2*(G/λ)\hat{ }0.3 applies to the width B of the required contact surface in comparison to the overall contact surface A, wherein G is a maximum gap width between a side surface and a battery module in mm in the compressed state, and A is the heat conductivity of the filling material in W/(m*K). This condition applies in particular for substantially rectangular side surfaces of the profile element, on which side surfaces the filling material can be arranged in strips which extend along a longitudinal direction over the entire length of the side surfaces and are arranged at a distance from one another in a width direction oriented transversely with respect to the longitudinal direction and therefore cover only part of the side surfaces. In such a case, the variable B can be the sum of the width of individual filling material strips, and therefore, for example, B=B1+B2+B3, applies to B, wherein B1, B2 and B3 are the respective widths of three filling material strips spaced apart from one another.

The equation 0.8*(G/λ)\hat{ }0.3<(B/A)<1.2*(G/λ)\hat{ }0.3 can therefore define an upper and a lower limit for the overall width of all of the filling material strips which are arranged on a respective overall width of the side surface A of the profile element. Below a minimum width B, the temperature gradient in the region of the filling material at maximum cooling power, i.e. at a maximum heat flow to be conducted out of the battery module, is too high (for example >12 K), and therefore the battery can no longer be sufficiently cooled, which leads to thermal ageing of the battery. Above a maximum width B, the forces required for compressing the filling material during the installation are too high (for example >2000 N), and therefore the battery or the battery modules could be mechanically destroyed. The stated range for the width B restricts the amount of filling material used, and therefore the weight and the costs of the cooling module as a whole are reduced while at the same time reliable operation of the battery is ensured.

The technical problem on which the invention is based is furthermore solved by a method for producing a cooling module for the active cooling of a battery which has at least two battery modules, in which the following method steps are passed through:

A) Providing a profile element which has at least one interior space for the passage of a cooling medium and at least two side surfaces which face away from one another and are designed to be assigned in each case to one of the battery modules;
B) Applying a filling material for producing a heat-conducting connection between the profile element and the battery modules to the side surfaces, characterized in that a contact surface which is formed between the respective side surface and the filling material arranged on said side surface is smaller than the respective side surface.

According to a development of the above-described method, the filling material is applied in working step B) to the side surfaces in an extrusion process, wherein the filling material is in particular in a molten or pasty state. Therefore, the filling material can be efficiently applied in a continuous process.

According to an alternative refinement of the method according to the invention, the filling material is applied to a backing film prior to the application to the side surfaces in an extrusion process, wherein the arrangement of the filling material on the backing film takes place in particular in strips which are spaced apart from one another. The relative arrangement of the filling material strips can therefore already be predetermined prior to the application of the filling material to a side surface of the profile element. The application of the filling material, which is provided in this manner on a backing film, to the profile element can therefore take place in working step B) by aligning and adhesively bonding the backing film with and to one of the side surfaces of the profile element.

Consequently, for a predetermined, in particular standardized, profile element, the arrangement of the filling material strips can be varied depending on the required application since the filling material is first of all provided on the backing film separately and independently of the profile element.

The invention is described in more detail below with reference to a drawing illustrating embodiments. In the drawing, in each case schematically:

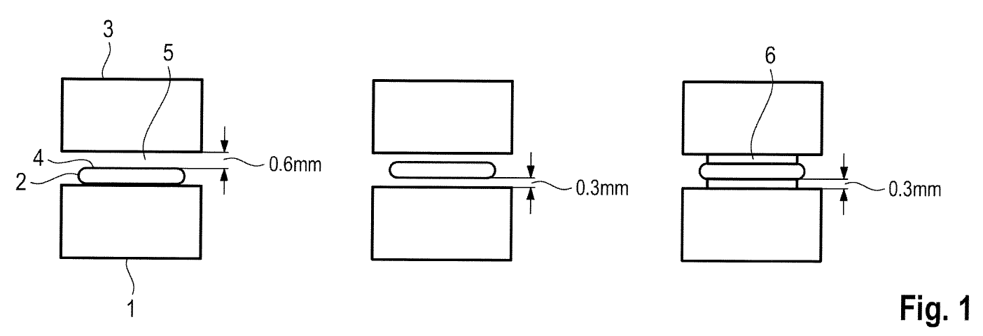

FIG. 1 shows an arrangement according to the prior art;

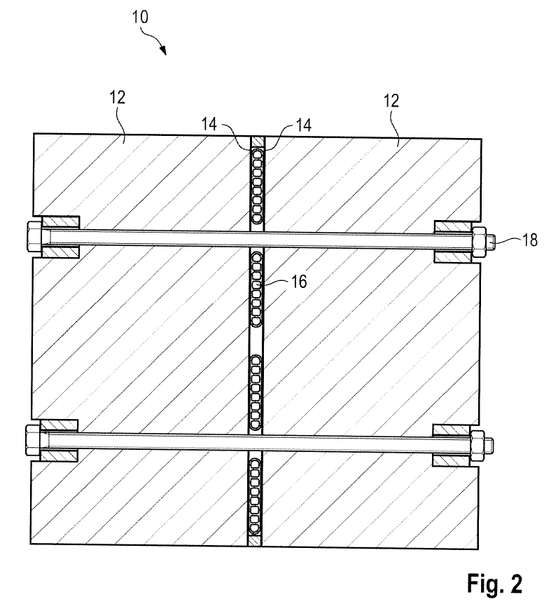

FIG. 2 shows a cross section through a battery according to the invention;

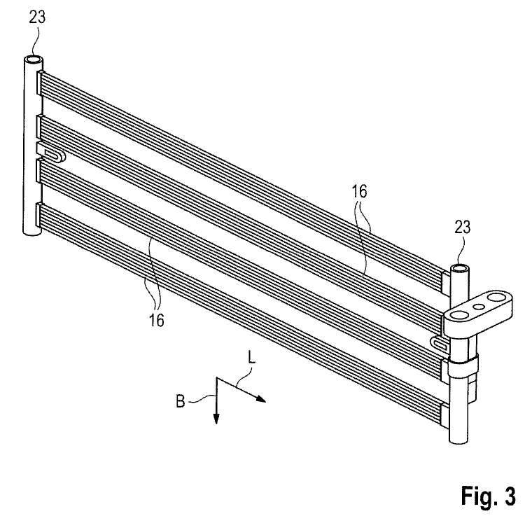

FIG. 3 shows an arrangement of cooling modules according to the invention;

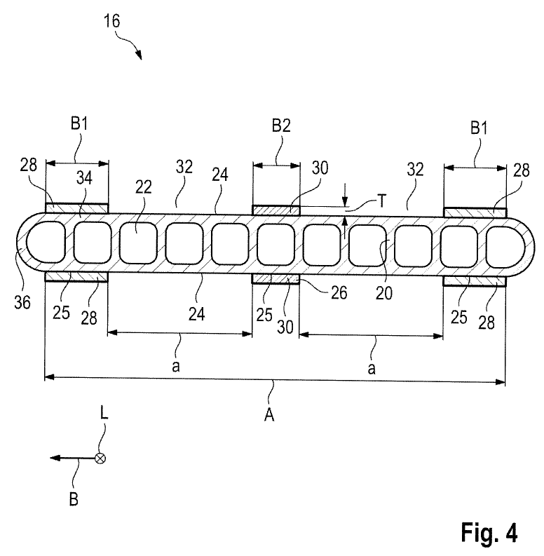

FIG. 4 shows a cross section of a cooling module according to the invention;

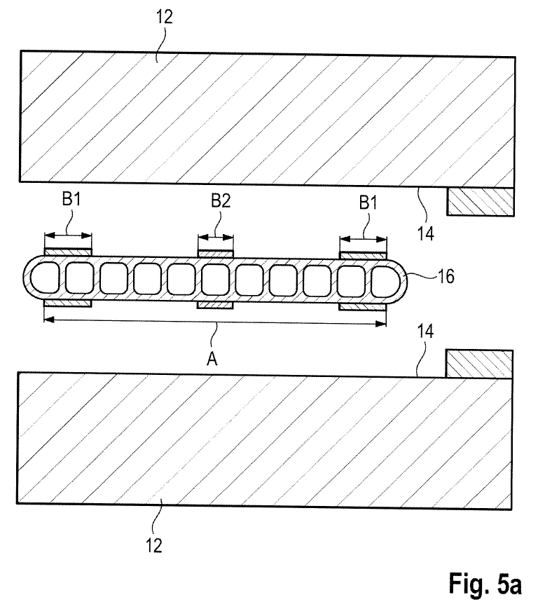

FIG. 5 shows a cross section of a battery according to the invention;

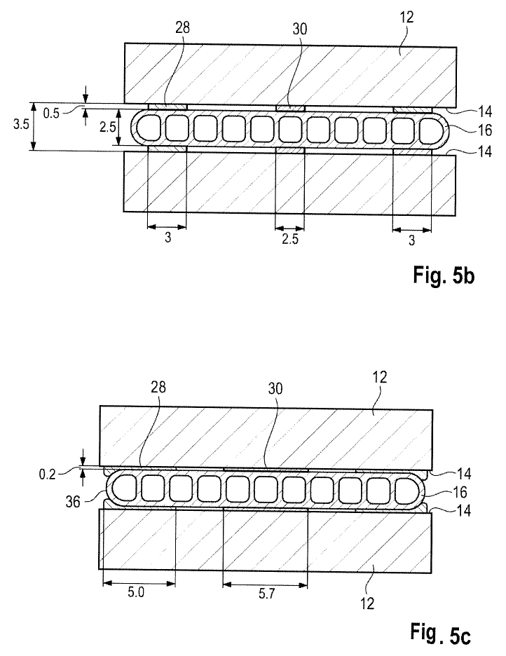

FIG. 6 shows a cross section of a cooling module according to the invention;

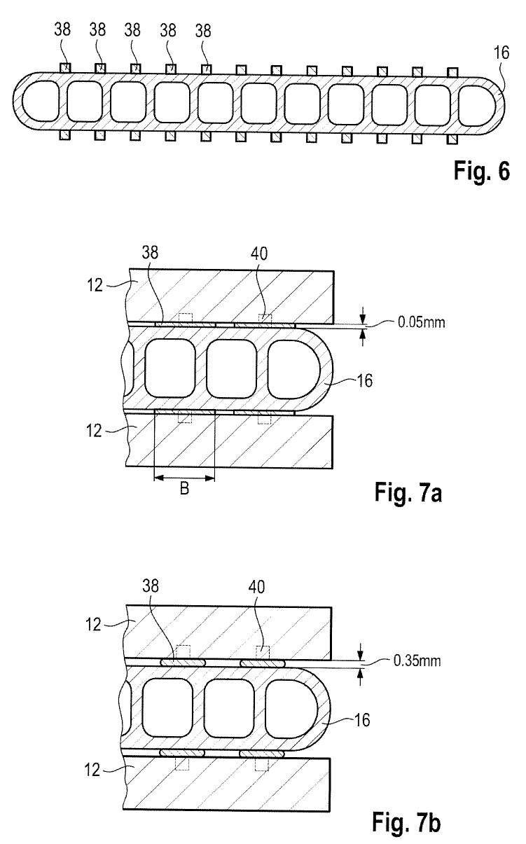

FIG. 7 shows the cooling module from FIG. 6 in a cross section in the mounted state;

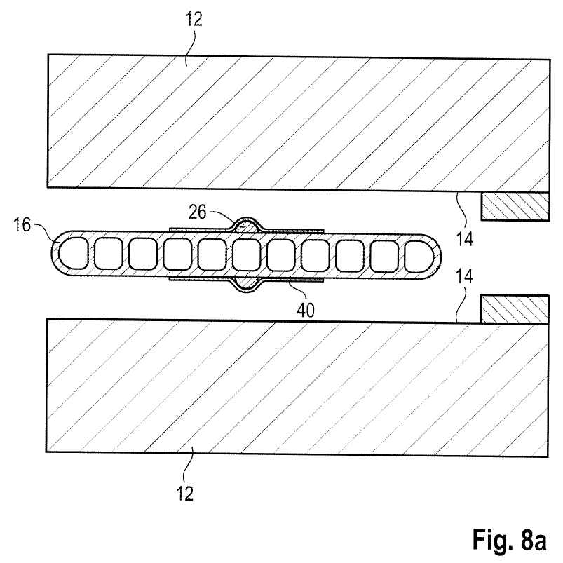

FIG. 8 shows a further refinement of a battery according to the invention;

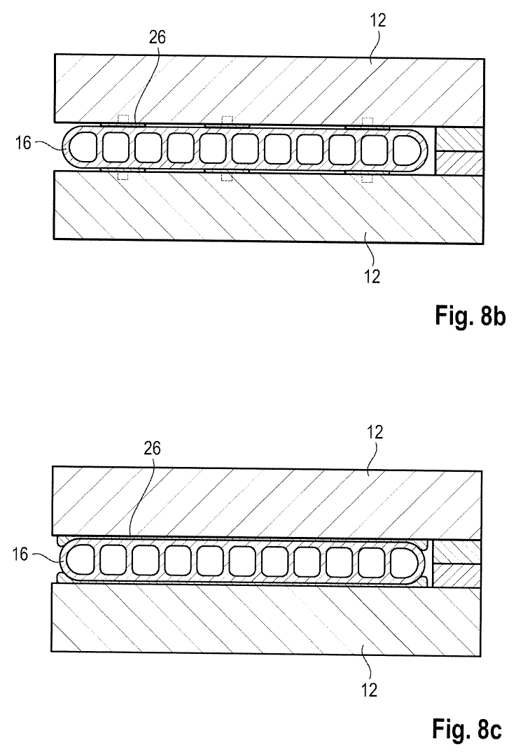

FIG. 9 shows an arrangement of filling material on a backing film;

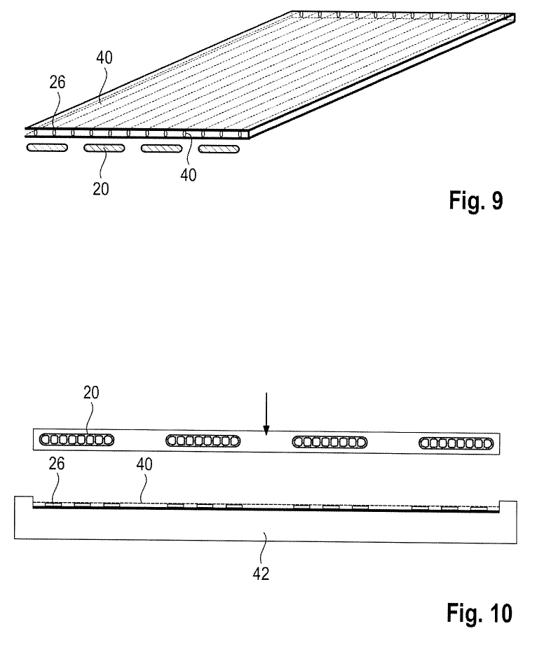

FIG. 10 shows an installation device for the installation of the backing film from FIG. 9;

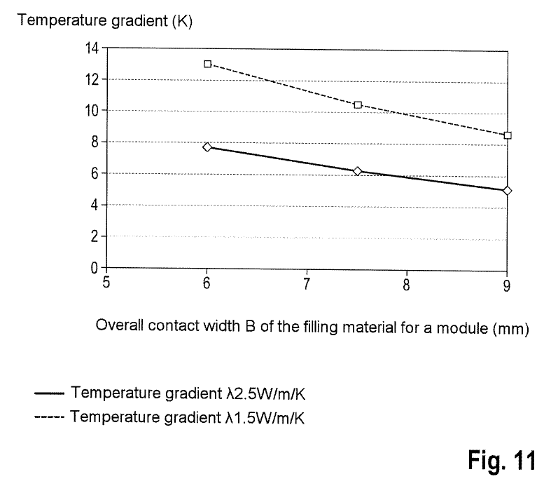

FIG. 11 shows simulation results for the design of the cooling modules;

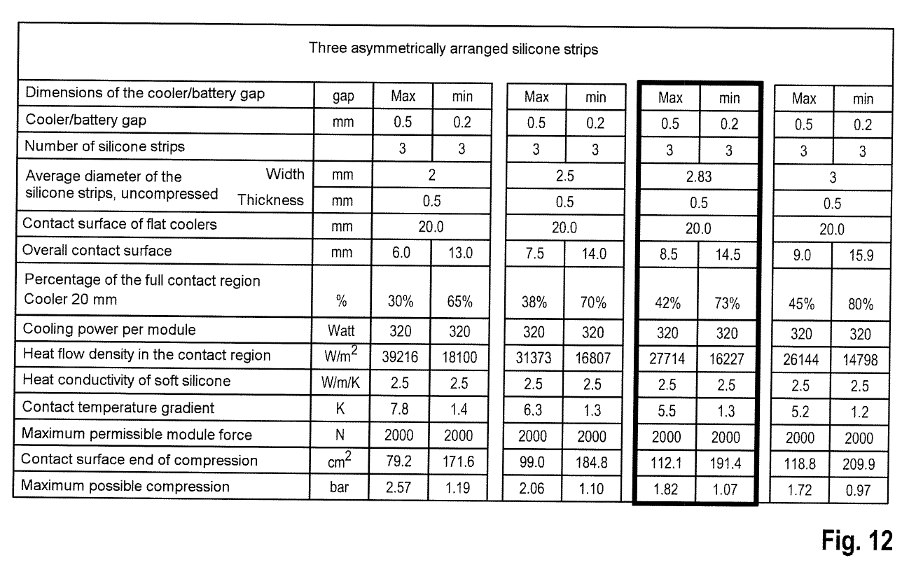

FIG. 12 shows simulation results for the design of the cooling modules;

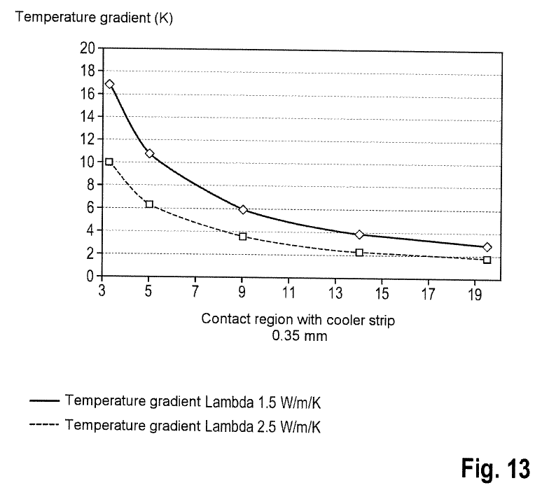

FIG. 13 shows simulation results for the design of the cooling modules.

The problem on which the invention is based is outlined below with reference to FIG. 1.

Two batteries or battery modules 1 arranged adjacent to each other are to be cooled with a cooling module 2 arranged between said battery modules 1. Bottom surfaces 3 of the battery modules 1 are assigned here to side surfaces 4 of the cooling module 2. Owing to the flatness and evenness tolerances of the bottom surfaces 3, the gap width of a gap 5 which is bounded between the bottom surfaces 3 and in which the cooling module 2 is arranged has a tolerance of +/−0.3 mm. So that the cooling module 2 can be reliably accommodated in the region of the gap 5, the wall thickness of the cooling module 2 is designed with regard to the minimum gap width. For the situation in which such a cooling module 2 is accommodated in a gap 5 which has a maximum gap width, there is a play of 0.6 mm between the side surfaces 4 of the cooling module 2 and the bottom surfaces 3 of the battery modules 1. In such a case, the cooling module 2 can be arranged in such a manner that there is contact with one of the battery modules 1, while at the same time a distance of 0.6 mm from the other battery module 1 is formed. Alternatively, there is an air gap, for example an air gap of 0.3 mm, in each case on two sides with respect to the two battery modules 1 to be cooled. In the first case, only the battery module 1 which is in contact with the cooling module 2 is sufficiently cooled. The battery modules 1 are therefore cooled to greatly differing extents, wherein the battery module 1 arranged at a distance from the cooling module 2 may be damaged because of a lack of sufficient cooling. This applies equally to the arrangement of the cooling module 2 with an air gap on two sides, wherein the two battery modules 1 are insufficiently cooled in this case.

In order to counter this problem, it is known to provide filling material 6 between the cooling module 2 and the battery modules 1, wherein the filling material 6 completely covers the side surfaces 4 assigned to the battery modules 1. When this arrangement is installed, the filling material 6 is compressed between the cooling module 2 and the battery modules. There is the problem that the installation forces which are required for compensating for the manufacturing tolerances exceed the forces tolerable by the battery modules 1, even for a soft filling material with a Shore hardness (00) of 20 to 40, and therefore, for example, a deformation, in particular a distortion, of the battery modules 1 may occur.

FIG. 2 shows a cross section through a battery 10 according to the invention. The battery 10 has two battery modules 12 which are arranged adjacent to and at a distance from each other. The battery modules 12 have mutually facing bottom surfaces 14 which are oriented substantially parallel to each other. Cooling modules 16 according to the invention are arranged between the battery modules 12. The cooling modules 16 are braced between the bottom surfaces 14 of the battery modules 12 with the aid of clamping elements 18. In the present case here, the clamping elements 18 are threaded rods braced with nuts.

The individual cooling modules 16 each comprise a profile element 20. Such a profile element 20 has a multiplicity of cooling channels 22 which are arranged adjacent to one another and are oriented parallel to one another along a longitudinal extent L of the respective profile element 20 (FIG. 4).

FIG. 3 shows an arrangement of four cooling modules 16 according to the invention which lead on the end sides into a pipe 23 which is joined into a cooling circuit (not illustrated). A cooling medium (not illustrated) can be conveyed through the cooling channels 22 of the cooling modules 16 via said cooling circuit.

FIG. 4 shows a cross section of a cooling module 16 according to the invention along a width direction B oriented transversely with respect to the longitudinal direction L. The cooling module 16 has side surfaces 24 on which filling material 26 is arranged in strips 28, of the width B1 and B2. Outer strips 28 have the width B1 while the inner strips 30 have the width B2. The width B1 is larger than the width B2. The overall width A of the respective side surface 24 is greater than the sum of the individual widths B1+B2+B1 of the filling material strips 28, 30, and therefore intermediate spaces 32 are in each case formed between the filling material strips 28, 30. Therefore, the side surfaces 24 are only partially covered with filling material 26. The area of a contact surface 25 formed in each case between the filling material strips 28, 30 and the side surfaces 24 is therefore smaller than the area of the respective side surface 24. In other words: the filling material covers only a part of the side surfaces while another part remains free.

The strips 28 are in each case arranged in an edge region 34 of the side surfaces 24. The edge region 34 is adjacent to narrow sides 36 connecting the side surfaces 24. The narrow sides 36 are formed by a radius, and therefore a smooth transition is formed from a respective flat side surface 24 to the narrow sides 36.

The strip 30 of filling material (or else the plurality of strips 30) can either be distributed uniformly between the outer strips 28 or optionally also arranged asymmetrically. It is important for a respective intermediate space to remain between adjacent strips, said intermediate space making it possible for the strips to expand laterally during the installation.

The installation of a battery 10 according to the invention is explained in more detail below with reference to FIGS. 5a, 5b and 5c. The cooling module 16 according to the invention shown previously in FIG. 4 is positioned between the bottom surfaces 14 of the battery modules 12. FIG. 5a shows a state of the components 12 and 16 to be braced together, prior to the bracing. FIG. 5b and FIG. 5c show the battery according to the invention in a ready mounted, compressed state.

FIG. 5b illustrates the case of a maximum gap width between the mutually facing bottom surfaces 14 of the battery modules 12, wherein the gap width is 3.5 mm. In this case, the thickness of the filling material strips 28, 30 is 0.5 mm, the width B1 is 3 mm and the width B2 is 2.5 mm. The wall thickness of the cooling module 16 is 2.5 mm.

FIG. 5c illustrates the case of a minimum gap width between the mutually facing bottom surfaces 14 of the battery modules 12, wherein the gap width here is 2.9 mm. In comparison to the state described in FIG. 5b, the filling material strips 28, 30 are significantly more greatly compressed and deformed. The width B1 in the case of a minimum gap width is 5 mm while the width B2 is 5.7 mm. It can be seen that the outer filling material strips 28 are pushed in the region of the radius of the narrow sides 36 into the widening clearance.

FIG. 6 shows a further refinement of a cooling module 16 according to the invention, wherein, in comparison to the above-described example, a substantially greater number of narrow filling material strips 38 is provided.

FIG. 7 describes the ready mounted state of the cooling module from FIG. 6. FIG. 7a shows the case of a minimum gap width, wherein the filling material has been compressed to a thickness of 0.05 mm. FIG. 7b illustrates the maximum gap width of this arrangement, wherein the filling material strips 38 are compressed to a thickness of 0.35 mm. The large number of narrow filling material strips 38 permits greater deformation of the filling material strips 38 while the compression forces can simultaneously be reduced. As a result, a minimum gap width of 0.05+/−0.02 mm can be achieved. In FIGS. 7a and 7b, the outlines 40 indicate the thickness of the filling material strips in the preassembled, uncompressed state. In the uncompressed state, the thickness of the filling material strips 38 is greater than the maximum gap width in the compressed state.

FIG. 8 shows a further refinement of a battery 10 according to the invention before and after the installation of the individual components 12, 16. The cooling module 16 shown between the battery modules 12 in FIG. 8a differs from the above-described embodiments in that the filling material 26 is covered by a protective film or backing film 40. The backing film 40 serves to protect the filling material 26 against mechanical or chemical environmental influences during the transport or the storage of the cooling modules 16. The backing film is removed before the cooling module 16 is compressed. FIG. 8b shows the state of the maximum gap width of 0.35 mm for the described arrangement, while FIG. 8c reproduces the state of the minimum gap width of 0.05 mm. As can be seen in FIG. 8c, the filling material 26 has been partially pressed into the region of the narrow sides 36 by the installation process. In order to limit the installation forces or compression forces, the minimum gap width has been limited to 0.05 mm.

FIGS. 9 and 10 show the production of cooling modules with the aid of a backing film 40. The filling material 26 is provided together with the backing film 40 separately from the profile elements 20. The filling material 26 is arranged on the backing film 40 in strips spaced apart from one another. In the present case here, the filling material 26 is enclosed on both sides by backing film 40. The unit of backing film 40 and filling material 26 is positioned in an installation aid 42. The backing film 40 facing the profile elements 20 is removed, and the profile elements 20 are compressed with the filling material strips 26. The filling material 26 adheres adhesively to the side surfaces 24 of the profile elements 20. The backing film 40 which faces away from the profile elements 20 initially remains on the filling material for the transport and the storage of the cooling modules 16 and provides protection for the filling material. The backing film or protective film 40 is removed prior to the final installation of such a cooling module in a battery 10.

FIGS. 11, 12 and 13 each show simulation results which can be used for designing the cooling modules 16.

In FIG. 11, the temperature difference occurring between a battery bottom surface and a side surface of the cooling module is plotted in K over the entire contact width B of the filling material in mm, wherein B is the sum of the widths of separate filling material strips. The plots apply to a maximum gap width of 0.5 mm between a battery module bottom surface and the side surface of the cooling module and 80 W cooling power for a cooling module with a length of 340 mm. The maximum contact width B for a side surface completely covered with filling material is 20 mm. The thickness of the filling material strips is 0.5 mm.

FIG. 12 is a list in table form of simulation results for filling material strips with a thickness of 0.5 mm and a heat conductivity of 2.5 W/(m*K). The simulations reveal that it is sufficient for the cooling of a battery module if only 5.5 mm of the overall width of 20 mm of the profile element are covered with filling material. The contact width B can therefore be only 28% of the maximum contact width. The temperature of the battery bottom surface can thus be kept below 18° C., wherein the temperature difference occurring between the battery bottom surface and the side surface of the cooling module is up to 6 K and the evaporation temperature of a cooling medium conducted within the profile element is 5° C.

FIG. 13 shows a further simulation result, wherein, in comparison to the plots described in FIG. 11, the basis here is a maximum gap width of 0.35 mm. The simulations reveal that it suffices for the cooling of a battery module if only 6 mm of the overall width of 20 mm of the profile element are covered with filling material (heat conductivity 2.5 W/(m*K)). The contact width B can therefore be only 33% of the maximum contact width. The temperature of the battery bottom surface can thus be kept under 18° C., wherein the temperature difference occurring between the battery bottom surface and the side surface of the cooling module is up to 6 K, and the evaporation temperature of a cooling medium conducted within the profile element is 5° C.

1. A cooling module for the active cooling of a battery which has at least two battery modules, the cooling module comprising:
a profile element comprising at least one interior space for the passage of a cooling medium; and
at least two side surfaces which face away from one another and are assigned in each case to one of the two battery modules,
wherein filling material for producing a heat-conducting connection between the profile element and the two battery modules is arranged on the side surfaces,
wherein the filling material in each case covers only a part of the side surface of the profile element.

2. The cooling module according to claim 1, wherein the filling material is arranged in strips on the side surfaces, wherein the strips assigned to a side surface are at a distance from one another, and wherein the strips are arranged substantially parallel to one another.

3. The cooling module according to claim 1, wherein the profile element has narrow sides which are adjacent to the side surfaces of the profile element, and at least a part of the filling material is arranged in an edge region of a side surface, which edge region is assigned to the narrow sides.

4. The cooling module according to claim 3, wherein at least one strip which is composed of filling material and is arranged in the edge region of the side surface is adjacent to the narrow side assigned to the edge region, and/or at least one outer strip (28) which is composed of filling material and is assigned to the edge region is wider than an inner strip arranged at a distance from the edge region.

5. The cooling module according to claim 3, wherein the side surfaces and the narrow sides merge smoothly into one another, wherein a radius is formed between the side surfaces and the narrow sides.

6. The cooling module according to claim 2, wherein a condition 2 mm≤a≤10 mm applies to a distance formed between adjacent filling material strips.

7. The cooling module according to claim 1, wherein the area of the entire contact surface of all of the filling material strips arranged on a side surface is 5% to 80% of the area of the respectively assigned side surface, and wherein the filling material is in a preassembled, uncompressed state.

8. The cooling module according to claim 1, wherein the area of the entire contact surface of all of the filling material strips arranged on a side surface is at least 30% and at most 90% of the area of the side surface within the range of 70% to 90%, in a ready mounted, compressed state.

9. The cooling module according to claim 1, wherein the filling material is an elastomer comprising a soft silicone, wherein the filling material contains additives for increasing the heat conductivity.

10. The cooling module according to claim 1, wherein a condition 0.3 mm≤T≤0.8 mm applies to the thickness T of the filling material.

11. The cooling module according to claim 1, wherein a condition 1≤H≤Shore (A) or the condition 20≤H≤70 Shore (00) applies to the hardness H of the filling material.

12. The cooling module according to claim 1, wherein a condition 0.7 W/(m*K)≤λ≤8 W/(m*K) applies to the heat conductivity λ of the filling material.

13. The cooling module according to claim 1, wherein the filling material is covered by a protective film.

14. A battery for a vehicle, with at least two battery modules and a cooling module as claimed in claim 1 for the active cooling of the battery modules, wherein the cooling module is arranged between the battery modules.

15. The battery according to claim 14, wherein an entire width of the contact surfaces in comparison to the width of the side surface A lies within the range of 0.8*(G/λ)\hat{ }0.3<B/A<1.2*(G/λ)\hat{ }0.3, wherein G is a maximum gap width between a side surface and a battery module in mm in the compressed state, and λ is the heat conductivity of the filling material in W/(m*K).

16. A method for producing a cooling module for the active cooling of a battery which has at least two battery modules, the method comprising:
A) Providing a profile element which has at least one interior space for the passage of a cooling medium and at least two side surfaces which face away from one another and are designed to be assigned in each case to one of the battery modules; and
B) Applying a filling material for producing a heat-conducting connection between the profile element and the battery modules to the side surfaces,
wherein a contact surface which is formed between the respective side surface and the filling material arranged on said side surface is smaller than the respective side surface.

17. The method according to claim 16, wherein the filling material is applied in working step B) directly to the side surfaces in an extrusion process, wherein the filling material is in a molten or pasty state.

18. The method according to claim 16, wherein the filling material is applied to a backing film prior to the application to the side surfaces in an extrusion process, wherein the arrangement of the filling material on the backing film takes place in strips which are spaced apart from one another.
